(19) United States
(12) Patent Application Publication
(10) Pub. No.: US 2008/0102926 A1
(43) Pub. Date: May 1, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/790,459

(22) Filed: Apr. 25, 2007

Related U.S. Application Data
(60) Provisional application No. 60/854,070, filed on Oct. 25, 2006.

(51) Int. Cl. A63F 13/00

(52) U.S. Cl. 463/20; 463/16

(57) ABSTRACT

The plural symbols of a plurality of areas are respectively scrolled and rearranged. Under state before one symbol is rearranged, when a symbol to be rearranged is as a stage having a possibility that a winning will occur in connection with the symbols having been already rearranged, an area width is enlarged in the scroll direction so that the arrangement number of the symbols is increased, for the area in which the symbols are scrolled.

### CROSS-REFERENCE TO RELATED APPLICATIONS

This application claims the benefit of U.S. Provisional Application No. 60/854,070, filed on Oct. 25, 2006.

### BACKGROUND OF THE INVENTION

1. Field of the Invention

The invention relates to a slot machine and a playing method thereof.

2. Description of Related Art

In a conventional slot machine, when a player inserts a game medium such as coin or bill into an insertion slot of the slot machine and pushes a spin button, plural symbols are scroll-displayed in a display mounted on a front of a cabinet and the symbols are then stopped automatically.

In such slot machine, as disclosed in U.S. Pat. No. 6,604,999 B2 or U.S. Patent No. 2002065124A1, for example, when the symbols stopped on a payline constitute a predetermined combination, predetermined number of game media are paid out. In addition, when a certain symbol referred to as scatter symbol is displayed on the display, predetermined number of game media are paid out in accordance with the number of scatter symbols displayed, irrespective of the payline. In other words, in the conventional slot machine, the payout is made in combination with the two methods.

The invention provides a slot machine having a new entertainment characteristic and a playing method thereof.

### SUMMARY OF THE INVENTION

The invention provides a slot machine comprising: plural symbols arranged in a plurality of areas; a symbol arranging device for arranging the plural symbols in the areas; and a game controller programmed to enable the symbol arranging device (a) to scroll and rearrange each of the symbols in each of the areas, respectively, based on a predetermined timing, (b) to determine a winning through a relation of the symbols rearranged, and (c) under state before the symbol is rearranged in a part of the area, when a symbol to be rearranged in the area is at a stage having a possibility that a winning will occur in connection with the symbols having been already rearranged in the areas, to enlarge an area width in the scroll direction so that an arrangement number of the symbols is increased, for the area in which the symbols are scrolled.

The invention provides a slot machine comprising: a display having a plurality of areas for arranging plural symbols; and a game controller programmed to enable the display (a) to scroll and rearrange the symbols in each of the areas, respectively, based on a predetermined timing, (b) to determine a winning through a relation of the symbols rearranged, and (c) under state before the symbol is rearranged in a part of the area, when a symbol to be rearranged in the area is at a stage having a possibility that a winning will occur in connection with the symbols having been already rearranged in the areas, to enlarge an area width in the scroll direction so that an arrangement number of the symbols is increased, for the area in which the symbols are scrolled.

The invention provides a slot machine comprising: a plurality of reels having plural symbols attached to each periphery thereof; a display provided to a front of the reels, having plural arrangement areas transmitting to arrange the symbols of the reels and being transmissive to any area; and a game controller programmed to enable the respective reels and the display (a) to rotate each of the reels on the basis of a predetermined timing, thereby scrolling and rearranging the symbols in the respective arrangement areas, (b) to determine a winning through a relation of the symbols rearranged, (c) under state before the symbol is rearranged in a part of the area, when a symbol to be rearranged in the area is at a stage having a possibility that a winning will occur in connection with the symbols having been already rearranged in the areas, to make the areas of the scroll direction transmissive and to enlarge an area width in the scroll direction so that an arrangement number of the symbols is increased, for the area in which the symbols are scrolled.

The invention provides a slot machine comprising: a symbol arranging device for arranging plural symbols in a plurality of areas; and a game controller programmed to enable the symbol arranging device (a) to scroll and rearrange the symbols in each of the areas, respectively, based on a predetermined timing, (b) to determine a winning through a relation of the symbols rearranged, and (c) under state before the symbol is rearranged in a part of the area, when a symbol to be rearranged in the area is at a stage having a possibility that a winning will occur in connection with the symbols having been already rearranged in the areas, to enlarge an area width in the scroll direction so that an arrangement number of the symbols is increased, for the area in which the symbols are scrolled, until a predetermined time period has lapsed from after the symbols are rearranged in all the areas.

The invention provides a playing method of a slot machine comprising: a display having a plurality of areas for arranging plural symbols; and a game controller programmed to enable the display (a) to scroll and rearrange the symbols in each of the areas, respectively, based on a predetermined timing, (b) to determine a winning through a relation of the symbols rearranged, and (c) under state before the symbol is rearranged in a part of the area, when a symbol to be rearranged in the area is at a stage having a possibility that a winning will occur in connection with the symbols having been already rearranged in the areas, to enlarge an area width in the scroll direction so that an arrangement number of the symbols is increased, for the area in which the symbols are scrolled, until a predetermined time period has lapsed from after the symbols are rearranged in all the areas.

The invention provides a playing method of a slot machine comprising: a plurality of reels having plural symbols attached to each periphery thereof; a display provided to a front of the reels, having plural arrangement areas transmitting to arrange the symbols of the reels and being transmissive to any area; and a game controller programmed to enable the respective reels and the display (a) to rotate the respective reels on the basis of a predetermined timing, thereby scrolling and rearranging the symbols in the respective arrangement areas, (b) to determine a winning through a relation of the symbols rearranged, and (c) under state before the symbol is rearranged in a part of the area, when a symbol to be rearranged in the area is at a stage having a possibility that a winning will occur in connection with the symbols having been already rearranged in the areas, to make the areas of the scroll direction transmissive and to enlarge an area width in the scroll direction so that an arrangement number of the symbols is increased, for the area in which the symbols are scrolled, until a predetermined time period has lapsed from after the symbols are rearranged in all the areas.

The invention provides a playing method of a slot machine for repeatedly executing a unit game in which plural symbols arranged by a symbol arranging device are rearranged. The symbol arranging device has a plurality of areas for arranging the plural symbols and the playing method comprises steps of: (a) scrolling and rearranging the symbols in each of the areas, respectively, based on a predetermined timing; (b) determining a winning thorough a relation of the symbols rearranged; and (c) under state before the symbol is rearranged in a part of the area, when a symbol to be rearranged in the area is at a stage having a possibility that a winning will occur in connection with the symbols having been already rearranged in the areas, enlarging an area width in the scroll direction so that an arrangement number of the symbols is increased, for the area in which the symbols are scrolled.

The invention provides a playing method of a slot machine for repeatedly executing a unit game in which plural symbols arranged by a display are rearranged. The display has a plurality of areas for arranging the plural symbols and the playing method comprises steps of: (a) scrolling and rearranging each of the plural symbols in each of the areas, respectively, based on a predetermined timing; (b) determining a winning thorough a relation of the symbols rearranged; and (c) under state before the symbol is rearranged in a part of the area, when a symbol to be rearranged in the area is at a stage having a possibility that a winning will occur in connection with the symbols having been already rearranged in the areas, enlarging an area width in the scroll direction so that an arrangement number of the symbols is increased, for the area in which the symbols are scrolled.

The invention provides a playing method of a slot machine comprising a game controller for repeatedly executing a unit game in which plural symbols arranged by a display are rearranged. The plural symbols are attached to peripheries of plural reels, the display has a plurality of areas for transmitting to arrange the symbols of the reels, is transmissive to any area and is provided to a front of the plural reels, and the playing method comprises steps of: (a) rotating the respective reels on the basis of a predetermined timing, thereby scrolling and rearranging the symbols in the respective arrangement areas, (b) determining a winning through a relation of the symbols rearranged, and (c) under state before the symbol is rearranged in a part of the area, when a symbol to be rearranged in the area is at a stage having a possibility that a winning will occur in connection with the symbols having been already rearranged in the areas, making the areas of the scroll direction transmissive and enlarging an area width in the scroll direction so that an arrangement number of the symbols is increased, for the area in which the symbols are scrolled.

The invention provides a playing method of a slot machine for repeatedly executing a unit game in which plural symbols arranged by a symbol arranging device are rearranged. The symbol arranging device has a plurality of areas for arranging the symbols and the playing method comprises steps of: (a) scrolling and rearranging each of the symbols in each of the areas, respectively, based on a predetermined timing, (b) determining a winning through a relation of the symbols rearranged, and (c) under state before the symbol is rearranged in a part of the area, when a symbol to be rearranged in the area is at a stage having a possibility that a winning will occur in connection with the symbols having been already rearranged in the areas, enlarging an area width in the scroll direction so that an arrangement number of the symbols is increased, for the area in which the symbols are scrolled, until a predetermined time period has lapsed from after the symbols are rearranged in all the areas.

The invention provides a playing method of a slot machine for repeatedly executing a unit game in which plural symbols arranged by a display are rearranged. The display has a plurality of areas for arranging the symbols and the playing method comprises steps of: (a) scrolling and rearranging the symbols in each of the areas, respectively, based on a predetermined timing, (b) determining a winning through a relation of the symbols rearranged, and (c) under state before the symbol is rearranged in a part of the area, when a symbol to be rearranged in the area is at a stage having a possibility that a winning will occur in connection with the symbols having been already rearranged in the areas, to enlarge an area width in the scroll direction so that an arrangement number of the symbols is increased, for the area in which the symbols are scrolled, until a predetermined time period has lapsed from after the symbols are rearranged in all the areas.

The invention provides a playing method of a slot machine comprising a game controller for repeatedly executing a unit game in which plural symbols arranged by a display are rearranged. The plural symbols are attached to peripheries of plural reels, the display has a plurality of areas for transmitting to arrange the symbols of the reels, is transmissive to any area and is provided to a front of the plural reels, and the playing method comprises steps of: (a) rotating the respective reels on the basis of a predetermined timing, thereby scrolling and rearranging the symbols in the respective arrangement areas, (b) determining a winning through a relation of the symbols rearranged, and (c) under state before the symbol is rearranged in a part of the area, when a symbol to be rearranged in the area is at a stage having a possibility that a winning will occur in connection with the symbols having been already rearranged in the areas, making the areas of the scroll direction transmissive and enlarging an area width in the scroll direction so that an arrangement number of the symbols is increased, for the area in which the symbols are scrolled, until a predetermined time period has lapsed from after the symbols are rearranged in all the areas.

### BRIEF DESCRIPTION OF THE DRAWINGS

FIG. 1 illustrates a playing method of a slot machine;

FIG. 2 is a block diagram of a slot machine;

FIG. 3 illustrates a display screen;

FIG. 4 illustrates a display screen;

FIG. 5 illustrates a display screen;

FIG. 6 illustrates a display screen;

FIG. 7 shows symbols and code numbers thereof;

FIG. 8 is a perspective view showing an external appearance of a slot machine;

FIG. 9 is a block diagram showing a control circuit of a slot machine;

FIG. 10 is a flow chart of a game executing process;

FIG. 11 is a flow chart showing a symbol display control process; and

FIG. 12 is a flow chart showing an arrangement area initializing process.

### DESCRIPTION OF THE PREFERRED EMBODIMENTS

### Embodiment

It will be described an embodiment of a slot machine and a playing method thereof according to the invention.

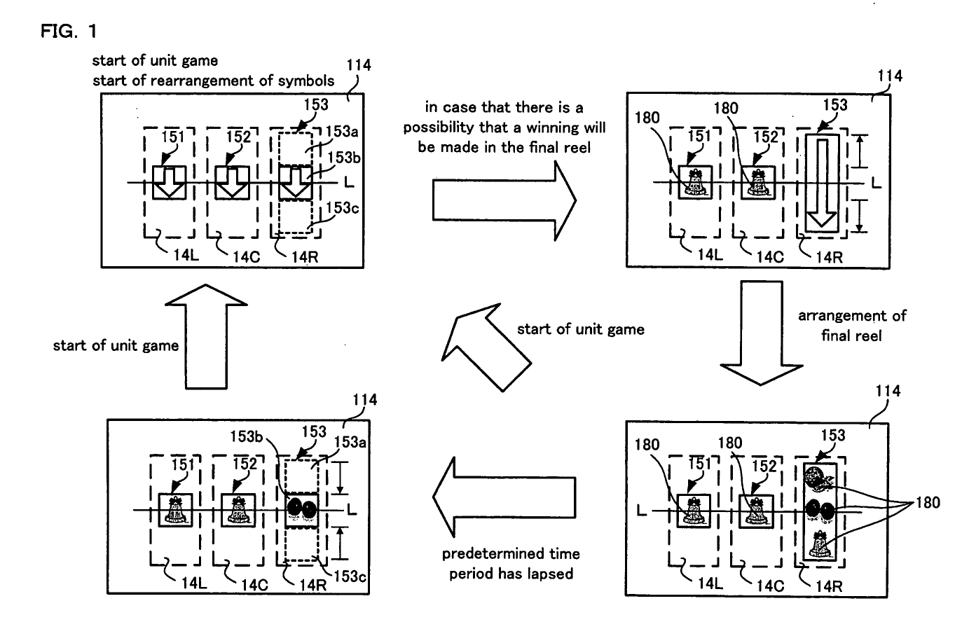

As shown in FIG. 1, a slot machine executes a playing method comprising steps of rotating each of three reels 14L, 14C, 14R on the basis of a predetermined timing, thereby scrolling and rearranging symbols of an arrangement area 115 (display windows 151˜153); determining a winning through a relation of the symbols 180 rearranged; and, under state before the symbols are rearranged in any one arrangement area (final arrangement area 153b), when a symbol to be rearranged in the area is at a stage having a possibility that a winning will occur in connection with the symbols having been already rearranged in the arrangement areas (display windows 151, 152), making the areas (enlargement areas 153a, 153c) of the scroll direction transmissive and enlarging an area width in the scroll direction so that an arrangement number of the symbols is increased, for the arrangement area (display window 153) in which the symbols are scrolled, until a predetermined time period has lapsed from after the symbols are rearranged in all the arrangement areas (display windows 151˜153).

Herein, the “arrangement” means a state in which the symbols 180 including the scatter symbol are allowed to be visible with naked eyes of an exterior player. In other words, in FIG. 1, the symbols 180 are under state of being displayed in the display windows 151˜153. In the mean time, the “rearrangement” is meant by arranging the reels again after dismissing the arrangement of the symbols 180. In addition, the “payline” L is provided to determine a combination of the symbols 180. Specifically, one payline L is set in the display windows 151˜153, so that one symbol 180 is respectively arranged on the payline L. In addition, in case that the enlargement areas 153a, 153c are under transmissive state in the display window 153, one symbol 180 is respectively arranged in the enlargement areas 153a, 153c and 3 (three) symbols 180 are arranged in the display window 153. Then, it is determined a combination of the symbols 180 rearranged on the payline L. As a result of the determination for a combination, when a winning combination is made, it is carried out, for example, a process of paying out a coin in accordance with the winning combination.

In addition, the “scatter symbol” is a symbol making it a condition that a winning is made through only the arrangement thereof, irrespective of the payline L. In other words, when the scatter symbol is rearranged, a winning is made and it is carried out, for example, a process of paying out a coin in accordance with the number of all the scatter symbols rearranged. In addition, when predetermined number of the scatter symbols is rearranged, a winning of the scatter symbol is made and a coin is paid out. Furthermore, the “symbol” 180 means all symbols used in the slot machine 10 and includes the scatter symbol. The payline L, the symbol 180, the winning combination and the display windows 151˜153 will be more specifically described later.

In addition, in a lower image display panel 16 which will be described later, the enlargement areas 153a, 153c are transmissive, so that parts of the symbols 180 attached to a periphery of a reel 14R provided to the rear are visible. This state is referred to a “transmissive state.” To the contrary, in the lower image display panel 16, the enlargement areas 153a, 153c are non-transmissive, so that the rear of the enlargement areas 153a, 153c are non-visible. This state is referred to a “non-transmissive state.”

(Symbol Arranging Unit 101)

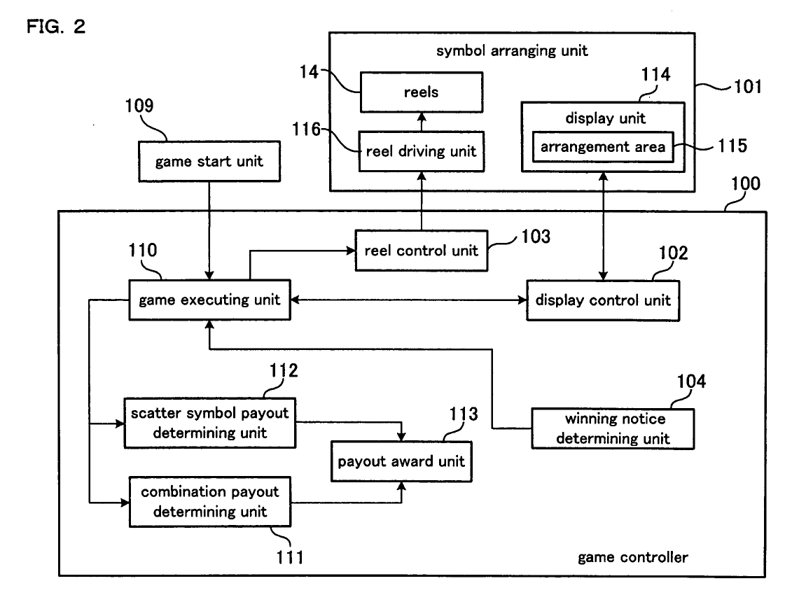

The slot machine executing the above playing method is provided with a symbol arranging unit 101 and a game controller 100, as shown in FIG. 2. The symbol arranging unit 101 is provided with a display unit 114 comprising the arrangement area 115 (display windows 151˜153), the reels 14 (14L, 14C, 14R) having the plural symbols 180, which include the scatter symbol, attached to peripheries thereof and a reel driving unit 116. The reel driving unit 116 rotates the reels 14, thereby arranging the symbols 180 in the arrangement area 115 (display windows 151˜153) having one payline L.

The symbol arranging unit 101 may be a mechanical structure with a reel device for arranging the symbols 180 by rotation of a reel, as described above, or an electrical structure with a video reel on which an image is displayed for arranging the symbols 180. Further, the symbol arranging unit 101 may be a structure of combining a mechanical structure (reel) and an electrical structure (video reel). The electrical structure may include a liquid crystal device, a CRT (cathode-ray tube), a plasma display and the like. In addition, the number of the display windows 151˜153 (arrangement area) and the number of the symbols 180 arranged in the respective display windows are not particularly limited. Further, the number of the payline L may be plural depending on the number of the display windows and the number of the symbols 180 arranged in the display windows. A detailed structure of the display unit 114 will be described later.

(Game Controller 100)

The game controller 100 is structured to execute a first process of rotating the reels 14 (14L, 14C, 14R) to arrange the symbols 180 in the arrangement area 115 (display windows 151˜153) and to scroll and rearrange the symbols 180 with different timings for each display windows 151˜153, a second process of awarding a payout determined by a combination of the symbols 180 rearranged on the payline L, a third process of when predetermined number or more of scatter symbols is rearranged, awarding a payout determined on the basis of the scatter symbol, a fourth process of under state before the symbol 180 is rearranged in the final arrangement area 153b, determining whether a symbol 180 to be rearranged in the final arrangement area 153b has a possibility that a winning will occur in connection with the symbols 180 having been already arranged in the display windows 151, 152, and a fifth process of making the areas (enlargement areas 153a, 153c) of the scroll direction transmissive and enlarging a width of the display window 153 in the scroll direction so that an arrangement number of the symbols 180 is increased, for the display window 153, until a predetermined time period has lapsed from after the symbols are rearranged in all the display windows 151˜153. In other words, the game controller 100 comprises first to fifth processing units.

The game controller 100 is provided with a display control unit 102 and a reel control unit 103. The display control unit 102 makes the enlargement areas 153a, 153c of the display window 153 transmissive. In addition, the reel control unit 103 rotates the reels 14 (14L, 14C, 14R) to scroll the symbols 180 in the arrangement area 115 and stops them to rearrange the symbols 180.

In addition, the game controller 100 is connected to a game start unit 109. The game start unit 109 has a function of outputting a game start signal in accordance with control of the player. The game controller 100 comprises a game executing unit 110 for rearranging the symbols with an input of a game start signal, as trigger, from the game start unit 109, a combination payout determining unit 111 for determining a payout determined by a combination of the symbols rearranged on the payline in a unit game, a scatter symbol payout determining unit 112 for determining a payout determined on the basis of the scatter symbol rearranged, irrespective of the payline L and a payout award unit 113 for awarding the respective payouts determined in the combination payout determining unit 111 and the scatter symbol payout determining unit 112.

Further, the game controller 100 has a winning notice determining unit 104. The winning notice determining unit 104 determines whether there is a symbol 180 whose a winning combination is made in connection with the symbols 180 having been already rearranged in the arrangement area 115 (display windows 151˜153) in a unit game.

In the mean time, each block of the game controller 100 may be structured with a hardware or software, as required.

(Operation of Game Controller 100)

In the above structure, an operation of the game controller 100 is described.

When a game start signal is outputted from the game start unit 109 by an operation of the player, the reel control unit 103 starts a process of rotating the reels and the game executing unit 110 starts a unit game, so that the symbols 180 are rearranged (first process). At this time, the symbols 180 are rearranged with different timings for each of the display windows 151˜153 by the reel control unit 103. When the unit game is executed to rearrange the symbols 180, the winning notice determining unit 104 determines whether there is a symbol 180 having a possibility that a winning will occur in connection with the symbols 180 having been already rearranged (fourth process). Then, when it is determined in the winning notice determining unit 104 that there is a possibility that a winning combination will be made, the display control unit 102 enlarges a width of the display window 153 in the scroll direction of the symbols 180 (fifth process).

Next, when all the symbols 180 are rearranged in the arrangement area 115 (display window 151˜153), a payout is awarded by the combination payout determining unit 111 and the payout award unit 113, which is determined by a combination of the symbols 180 rearranged on the payline L. Thereby, the game controller 100 rearranges the symbols, thereby executing the second process of awarding a payout determined by the combination of the symbols 180 rearranged on the payline L. In addition, a payout determined by the number of the scatter symbols rearranged is awarded by the scatter symbol payout determining unit 112 and the payout award unit 113. Thereby, the game controller 100 rearranges the symbols, thereby executing the third process of awarding the payout determined on the basis of the scatter symbol rearranged.

As can be seen from the above operation, the slot machine 10 embodies the playing method having the steps of rotating each of three reels 14L, 14C, 14R on the basis of a predetermined timing, thereby scrolling and rearranging symbols of the arrangement area 115 (display windows 151˜153), determining a winning through a relation of the symbols 180 rearranged, and, under state before the symbol is rearranged in any one area (final arrangement area 153b), when a symbol to be rearranged in the area is at a stage having a possibility that a winning will occur in connection with the symbols having been already rearranged in the arrangement areas (display windows 151, 152), making the areas (enlargement areas 153a, 153c) of the scroll direction transmissive and enlarging an area width in the scroll direction so that an arrangement number of the symbols is increased, for the arrangement area (display window 153) in which the symbols are scrolled, until a predetermined time period has lapsed from after the symbols are rearranged in all the arrangement areas (display windows 151˜153).

(Display State)

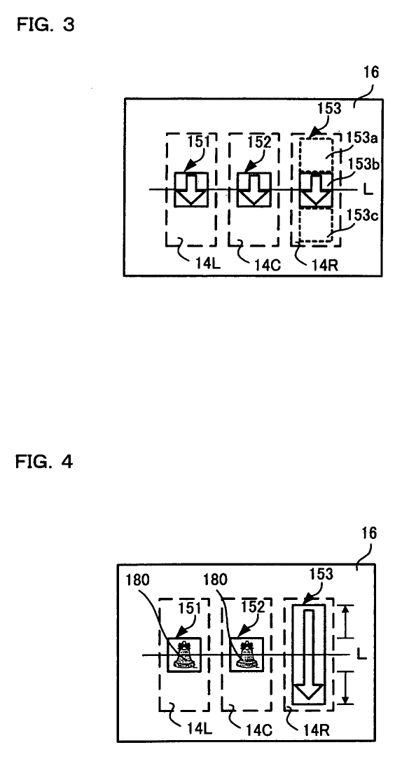

It is specifically described an example of a display state of the display unit 114, with respect to the operation processes of the slot machine 10 and the playing method. In the mean time, as shown in FIGS. 3 to 6, the display state is described with reference to a structure in which the reels 14 are mechanical reels and the reels 14 having the symbols 180 attached thereto are rotated to arrange the symbols in the arrangement area 115.

The display unit 114 has display windows 151˜153 as the arrangement area 115 for arranging the plural symbols. The display windows 151˜153 are arranged in a central part of the display unit 114. In the display windows 151˜153, the reels 14 provided to the rear and having the symbols 180 attached to peripheries thereof are rotated to scroll-display the symbols 180. In the respective display windows 151˜153, the rotation of the reels 14 is stopped, so that the symbols 180 are respectively stopped (arranged). For example, in FIG. 6, “BELL” is stopped in the display window 151, “BELL” is stopped in the display window 152 and “PLUM” is stopped in the display window 153. As a result, the display windows 151˜153 display a symbol matrix consisting of 3 columns and 1 row. In the mean time, the symbol matrix is not limited to 3 columns and 1 row.

In addition, the arrangement area 115 has the enlargement areas 153a, 153c as areas for enlarging a width of the display window 153 in the scroll direction of the symbol 180. Under state before the symbol is rearranged in the final arrangement area 153b, when a symbol to be rearranged in the area is at a stage having a possibility that a winning will occur in connection with the symbols having been already rearranged in the arrangement areas (display windows 151, 152), the enlargement areas 153a, 153c are made to be transmissive, so that the width of the display window 153 is enlarged in the scroll direction. One symbol 180 is respectively arranged in the enlargement areas 153a, 153c and three symbols 180 are arranged in the display window 153. In the mean time, the widths of the enlargement areas 153a, 153c to be enlarged in the scroll direction may be arbitrarily provided on condition that the arrangement number of the symbols 180 is increased.

In the symbol arranging unit 101 structured as described above, a display state of FIG. 3 shows a state just after the unit game is started. In other words, the display state of FIG. 3 is made before the symbols 180 are rearranged in the display windows 151˜153. The enlargement areas 153a, 153c are under non-transmissive state.

A display state of FIG. 4 shows a state just before the symbols 180 are rearranged in the display windows 151, 152 and then the symbols 180 are rearranged in the display window 153. “BELL” is stopped in the display window 151 and “BELL” is stopped in the display window 152. In other words, “BELL” is stopped on the payline L. The enlargement areas 153a, 153c are under transmissive state and the width of the display window 153 is enlarged in the scroll direction. Thereby, it is possible to enlarge a scroll range of the symbols in the display window 153, thereby enabling the player to easily understand the scroll of the symbols 180. At the same time, it is possible to make the player pay attention to the display windows 151˜153, so that the player can recognize that “BELL” is stopped in the display window 151 and a winning combination is thus made.

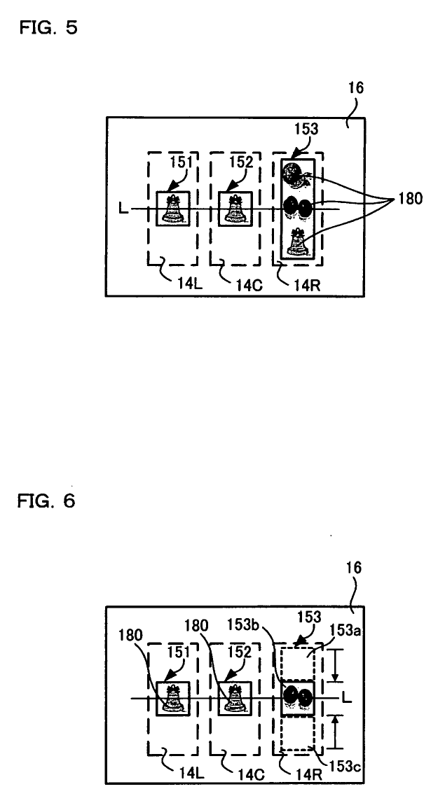

A display state of FIG. 5 shows that the enlargement areas 153a, 153c becomes under transmissive state and then the symbols 180 are rearranged in the display window 153. Specifically, “BELL” is stopped in the display window 151 and “BELL” is stopped in the display window 152. In the display window 153, “ORANGE” is stopped in the enlargement area 153a, “PLUM” is stopped in the final arrangement area 153b and “BELL” is stopped in the enlargement area 153c. In this case, although a winning combination is not made, the player can recognize that the symbol 180, which will be a winning combination, is arranged in the enlargement areas 153c. Thereby, it is possible to make the player have a desire for a winning combination more intensively, so that the player is motivated to continue the game.

A display state of FIG. 6 shows that after the enlargement areas 153a, 153c are under transmissive state, the symbols 180 are rearranged in the display window 153 and a predetermined time period has lapsed. When a predetermined time period has lapsed after the rearrangement, the enlargement areas 153a, 153c becomes under non-transmissive state from the transmissive state.

(Symbol, Combination, Etc.)

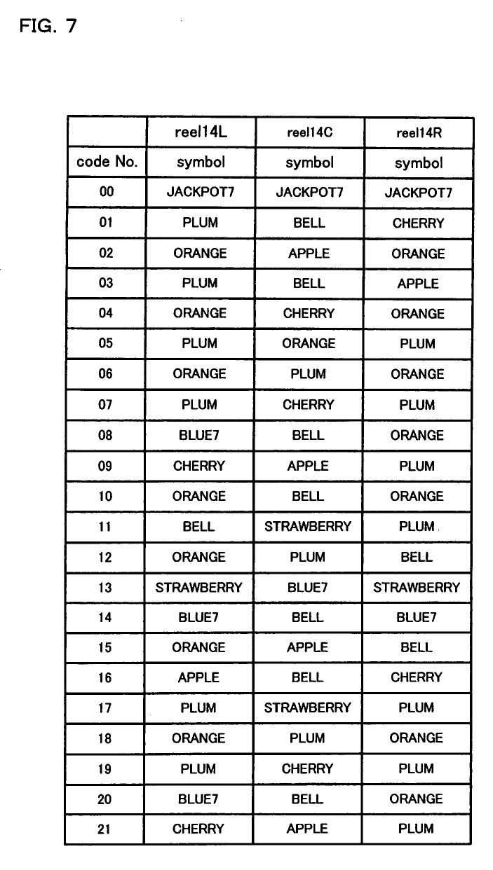

As shown in FIG. 7, the symbols 180 to be displayed in the display windows 151˜153 of the display unit 114 constitute columns of symbols consisting of 22 symbols. The symbols constituting the respective columns of symbols are given with one code number of 0˜21. Each of the columns of symbols is constituted with a combination of symbols of “JACKPOT 7,” “BLUE 7,” “BELL,” “CHERRY,” “STRAWBERRY,” “PLUM,” “ORANGE” and “APPLE.”

The three successive symbols in the columns of symbols are displayed (arranged) in the display windows 151˜153, respectively, so that they constitute a symbol matrix of 3 columns and 1 row in the display windows 151˜153. When a 1-BET button 26 or MAX-BET button 27 is pushed and then a spin button 23 is pushed, the reels 14 are rotated, so that the symbols 180 start to scroll. When the scroll starts, the scrolls of the respective symbols are stopped (rearranged) after a predetermined time period has lapsed.

In addition, various winning combinations are predetermined with regard to the respective symbols. The winning combination is a combination that a combination of symbols stopped on the payline L becomes an advantageous state to the player. The advantageous state is a state in which a coin is paid out in accordance with the winning combination, the payout-number of coins is added to a credit, a bonus game is started, and the like.

Specifically, when a combination of “APPLE” symbol is stopped on the payline L, a bonus is triggered and a gaming state is shifted to a bonus game from a basic game. In addition, when a symbol of “CHERRY” is stopped on the payline L, 20 coins (game medium) are paid out per one bet. When a symbol of “PLUM” is stopped on the payline L, 5 coins are paid out per one bet.

In the mean time, a bonus game is a gaming state that is more advantageous than a basic game. In one embodiment, the bonus game is a free game. The free game is a gaming state allowing a player to play a game for a predetermined number of times, without betting a coin. The bonus game is not particularly limited as long as it is a gaming state advantageous to the player, i.e., it is more advantageous than the basic game. For example, the bonus game may include a state in which it is possible to obtain more game medium than the basic game, a state in which it is possible to obtain a game medium in a higher probability than in the basic game, a state in which a game medium is less consumed than in the basic game, and the like. Specifically, a free game, a second game and the like are examples of the bonus game.

(Mechanical Structure)

In the followings, it will be described an example of the slot machine 10 structured in a mechanical and electrical manner.

The slot machine 10 is provided in a game arcade. The slot machine 10 executes a unit game by using a game medium. The game medium is a coin, bill or electronic negotiable information corresponding to them. Meanwhile, in the invention, the game medium is not particularly limited. For example, a medal, token, electronic money, ticket and the like can be used. The ticket is not particularly limited and may be a ticket with a barcode which will be described later.

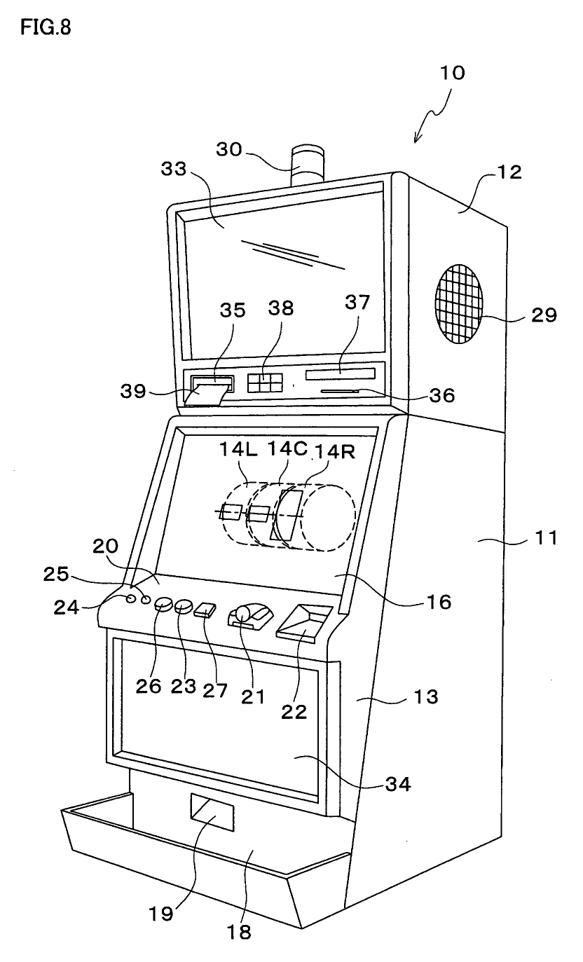

As shown in FIG. 8, the slot machine 10 comprises a cabinet 11, a top box 12 provided to an upper part of the cabinet 11 and a main door 13 provided to a front of the cabinet 11. The main door 13 is provided with a lower image display panel 16. The lower image display panel 16 has a transparent liquid crystal panel for displaying a variety of information. The lower image display panel 16 displays the parts of the plural symbols 180 of the reels 14L, 14C, 14R provided to the rear in the display windows 151˜153 under transmissive state and information and effect images relating to a game, as required.

In the mean time, in this embodiment, it is exemplified a case where the display windows 151˜153 are displayed in the lower image display panel 16 and the symbols of 3 columns and 1 row are displayed with the mechanical reels 14L, 14C, 14R having the symbols attached to the peripheries thereof. However, the invention is not limited thereto. For example, the symbol arranging unit 101 may be such structured that the symbols are arranged in a video reel manner.

The one activated payline L is displayed in the lower image display panel 16. In addition, the number of the payline L may be two or more. Furthermore, when two or more payline L are provided, the number of paylines L relating to a predetermined condition such as bet-number of coins may be activated.

In the mean time, a credit-number display unit and a payout-number display unit may be displayed in the lower image display panel 16. The credit-number display unit displays a total number that the slot machine 10 can pay out to a player (which will be referred to as total credit-number). The payout-number display unit displays number of coins to be paid out when a combination of symbols stopped on the payline L is a winning combination.

A control panel 20, a coin receiving slot 21 and a bill validator 22 are provided below the lower image display panel 16. The control panel 20 is provided with plural buttons 23˜27. The buttons 23˜27 allows instructions, which are related to a game progress by a player, to be inputted. The coin receiving slot 21 enables a coin to be received in the cabinet 11.

The control panel 20 is provided with a spin button 23, a change button 24, a cash out button 25, a 1-BET button 26 and a MAX-BET button 27. The spin button 23 is provided to rotate the reels 14 and is a button for inputting an instruction to start the scroll of symbols. The change button 24 is a button to be used when a player asks a staff in the game arcade for exchange of money. The cash out button 25 is a button for inputting an instruction to pay out the coins of total credit-number into a coin tray 18.

The 1-BET button 26 is a button for inputting an instruction to bet one coin, among coins of the total credit-number, per one game. The MAX-BET button 27 is a button for inputting an instruction to bet maximum coins (for example, 50 coins), among coins of the total credit-number, per one game.

The bill validator 22 validates whether bill is normal or not and receives the normal bill into the cabinet 11. In the mean time, the bill validator 22 can read a ticket 39 having a barcode which will be described later. When the bill validator 22 reads the ticket 39 having a barcode, it outputs a reading signal relating to the read content to a main CPU 41.

A belly glass 34 is provided to a lower frontal surface of the main door 13, i.e., below the control panel 20. A character of the slot machine 10 and the like are drawn on the belly glass 34. An upper image display panel 33 is mounted to a front of the top box 12. The upper image display panel 33 has a liquid crystal panel and displays, for example, an effect image and an image indicating an introduction of a game content and an explanation of a game rule.

To the top box 12 is mounted a speaker 29 for outputting voice. A ticket printer 35, a card reader 36, a data displayer 37 and a keypad 38 are provided below the upper image display panel 33. The ticket printer 35 prints a barcode having data encoded thereto, such as credit-number, date and time, identification number of the slot machine 10 and the like, onto a ticket, thereby outputting the ticket 39 having the barcode. The player can play a game in another slot machine with the ticket 39 having a barcode and exchange the ticket 39 having a barcode with bill in a change booth of the game arcade.

The card reader 36 reads and writes the data from and into a smart card. The smart card is a card carried by a player, into which data for identifying the player and data relating to a game history of the player are memorized.

The data displayer 37 consists of a fluorescent display and the like, and displays the data read by the card reader 36 and the data inputted by the player through the keypad 38. The keypad 38 inputs instructions or data relating to a ticket issue.

(Electrical Structure)

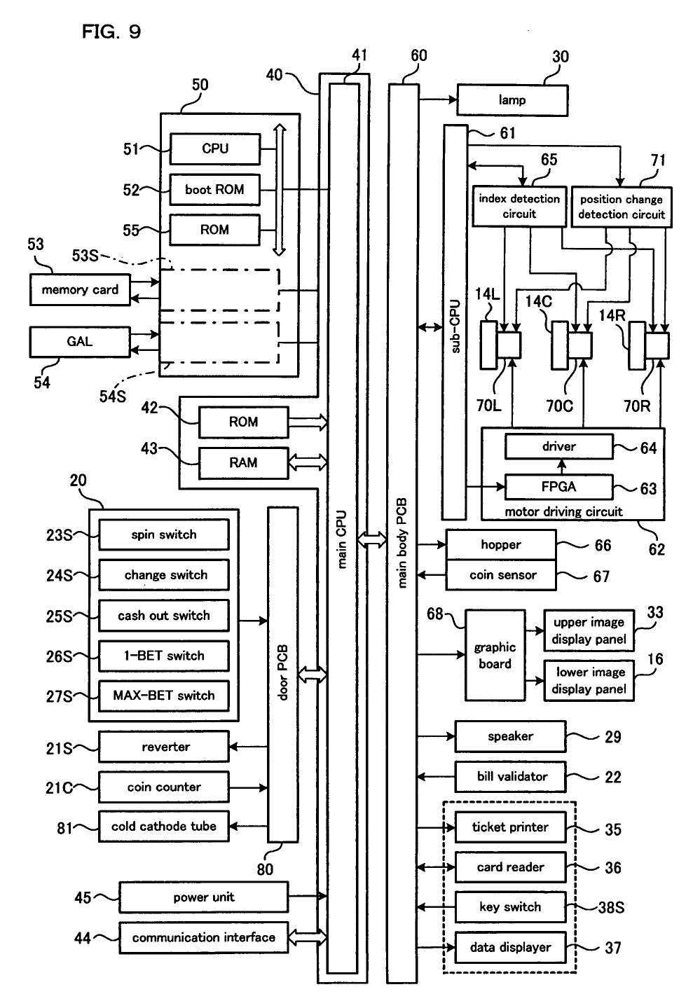

A control unit having the game controller 100 shown in FIG. 2 is mounted in the cabinet 11. As shown in FIG. 9, the control unit comprises a motherboard 40, a main body PCB (Printed Circuit Board) 60, a gaming board 50, a sub CPU 61, a door PCB 80, and various switches and sensors.

The gaming board 50 is provided with a CPU (Central Processing Unit) 51, a ROM 55 and a boot ROM 52 which are connected to each other by an internal bus, a card slot 53S corresponding to a memory card 53 and an IC socket 54S corresponding to a GAL (Generic Array Logic) 54.

The memory card 53 stores a game program and a game system program therein. The game program includes a stop symbol determining program. The stop symbol determining program is a program for determining a symbol (code number corresponding to the symbol) to be stopped on the payline L. The stop symbol determining program includes symbol weight data corresponding to each of plural payout rate (for example, 80%, 84%, 88%). The symbol weight data is data representing a correspondence relation between the code number of each symbol and 1 or plural random numbers belonging to a predetermined numerical range (0˜256) for each of the display windows 151˜153.

The payout rate is determined on the basis of data for setting a payout rate, which data is outputted from the GAL 54, and a stop symbol is determined on the basis of the symbol weight data corresponding to the payout rate.

Further, the memory card 53 stores various data used for the game program and the game system program. For example, the data representing a relationship between the symbols 180 displayed in the display windows 151˜153 in FIG. 1 and a range of the random numbers is stored in a table form. In the mean time, these data are transmitted to a RAM 43 of the motherboard 40 when executing the game program.

In addition, the card slot 53S is structured to insert and remove the memory card 53 and connected to the motherboard 40 through an IDE bus. Accordingly, it is possible to change a type or content of a game to be executed in the slot machine, by removing the memory card 53 from the card slot 53S, writing another game program and game system program in the memory card 53 and inserting the memory card 53 into the card slot 53S.

The game program includes a program relating to a game progress and a program for shifting a gaming state into a bonus game. In addition, the game program includes image data and music data which are outputted during the game.

The GAL 54 is provided with plural input and output ports. When the data is inputted into the input ports, the GAL 54 outputs data corresponding to the inputted data from the output ports. The data outputted from the output ports is the data for setting a payout rate which has been described above.

The IC socket 54S is structured to attach and detach the GAL 54. The IC socket 54S is connected to the motherboard 40 through a PCI bus. Accordingly, it is possible to change the data for setting a payout rate which is outputted from the GAL 54, by detaching the GAL 54 from the IC socket 54S, rewriting the program stored in the GAL 54 and then attaching the GAL 54 to the IC socket 54S.

The CPU 51, the ROM 55 and the boot ROM 52, which are connected to each other by the internal bus, are connected to the motherboard 40 through the PCI bus. The PCI bus carries out a signal transfer between the motherboard 40 and the gaming board 50 and supplies power to the gaming board 50 from the motherboard 40. The ROM 55 stores nation identification information and an authentication program. The boot ROM 52 stores a preliminary authentication program and a program (boot code) enabling the CPU 51 to execute the preliminary authentication program.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication to be authenticated is not falsified, i.e., for authenticating the authentication program.

The motherboard 40 is provided with a main CPU 41 (controller), a ROM (Read Only Memory) 42, a RAM (Random Access Memory) 43 and a communication interface 44.

The main CPU 41 has functions of a controller for controlling the whole slot machine 10. In particular, the main CPU 41 carries out a control for outputting a command signal enabling the sub CPU 61 to rotate the reels 14 when the spin button 23 is pushed after the credit is bet, a control for determining symbols to be stopped after the reels 14 are rotated and a control for stopping the determined symbols in the display windows 151˜153.

In other words, the main CPU 41 has functions of an arrangement controller for selecting and determining arrangement symbols with regard to a symbol matrix from the plural types of symbols so as to rearrange them, as a new symbol matrix after scrolling the plural symbols to be displayed in the lower image display panel 16, and executing an arrangement control which will be stopped at the determined symbols from the scroll state.

In addition, the main CPU 41 has functions of the game controller 100 for executing a first process of rotating the respective reels 14 (14L, 14C, 14R), based on a predetermined timing, to scroll and rearrange the symbols 180 in the arrangement area 115 (display windows 151˜153), a second process of determining a winning through a relation (winning combination) of the symbols rearranged, and a third process of rotating the reels after a predetermined condition is satisfied, thereby changing the scroll direction of the symbols.

The ROM 42 stores a program such as BIOS (Basis Input/Output System) executed by the main CPU 41, and data that is permanently used. When the BIOS is executed by the main CPU 41, each of peripheral devices is initialized and the game program and the game system program stored in the memory card 53 are read out through the gaming board 50. The RAM 43 stores the data and program used when the main CPU 41 carries out a process.

The communication interface 44 is provided to communicate with a host computer and the like through a communication line, which are mounted in the game arcade. In addition, the motherboard 40 is connected to the main body PCB (Printed Circuit Board) 60 and the door PCB 80 through a USB (Universal Serial Bus). Further, the motherboard 40 is connected to a power unit 45. When power is supplied to the motherboard 40 from the power unit 45, the main CPU 41 of the motherboard 40 is operated and the power is supplied to the gaming board 50 through the PCI bus, so that the CPU 51 is also operated.

The main body PCB 60 and the door PCB 80 are connected to a device or apparatus for producing an input signal which will be inputted to the main CPU 41, and a device or apparatus which is controlled by the control signal outputted from the main CPU 41. The main CPU 41 executes the game program and the game system program stored in the RAM 43, based on the input signal inputted to the main CPU 41 to carry out an arithmetic process, thereby storing a result thereof in the RAM 43 or transmitting a control signal to each device or apparatus to control it.

The main body PCB 60 is connected with a lamp 30, the sub CPU 61, a hopper 66, a coin sensor 67, a graphic board 68, the speaker 29, the bill validator 22, the ticket printer 35, the card reader 36, a key switch 38S and the data displayer 37.

The lamp 30 is turned on/off on the basis of the control signal outputted from the main CPU 41. The sub CPU 61 controls the rotation and stopping of the reels 14 (14L, 14C, 14R). The sub CPU 61 is connected with a motor driving circuit 62 having a FPGA (Field Programmable Gate Array) 63 and a driver 64. The FPGA 63 is an electronic circuit such as programmable LSI and serves as a control circuit of stepping motors 70. The driver 64 serves as an amplifying circuit of pluses inputted to the stepping motors 70. The motor driving circuit 62 is connected with the stepping motors 70 (70L, 70C, 70R) for rotating the reels 14, respectively. The stepping motor 70 is an excitation type of stepping motor having one or two phases.

According to the invention, the excitation type of stepping motor is not particularly limited. For example, two phase-excitation type or one type-excitation type may be adopted. Alternatively, a DC motor may be adopted instead of the stepping motor. When a DC motor is adopted, the sub CPU 61 is sequentially connected with a deviation counter, a D/A converter and a servo amplifier, and the DC motor is connected to the servo amplifier. In addition, a rotating position of the DC motor is detected by a rotary encoder and the current rotating position of the DC motor is supplied as data to the deviation counter from the rotary encoder.

In addition, the sub CPU 61 is connected with an index detection circuit 65 and a position change detection circuit 71. The index detection circuit 65 detects positions of the reels 14 being rotated and can detect a step-out of the reels 14.

The position change detection circuit 71 detects a change of the stop positions of the reels 14 after the reels 14 are stopped. For example, the position change detection circuit 71 detects a change of the stop positions of the reels 14, which is related to a case where the stop positions are changed to make a combination of the symbols which will forcibly be a winning combination by a player even though the combination of the symbols is actually not a winning combination. The position change detection circuit 71 detects, for example pins (not shown) mounted at a predetermined distance in the reels 14, thereby detecting a change of the stop positions of the reels 14.

The hopper 66 is mounted in the cabinet 11 and pays out predetermined number of coins to the coin tray 18 from the coin payout slot 19, based on the control signal outputted from the main CPU 41. The coin sensor 67 is mounted in the coin payout slot 19 and outputs an input signal to the main CPU 41 when it detects that the predetermined number of coins are paid out from the coin payout slot 19.

The graphic board 68 controls an image display in the upper image display panel 33 and the lower image display panel 16, based on the control signal outputted from the main CPU 41. In addition, the graphic board 68 is provided with a VDP (Video Display Processor) for producing image data on the basis of the control signal outputted from the main CPU 41, a video RAM for temporarily storing the image data produced by the VDP, and the like. Meanwhile, the image data, which is used to generate the image data by the VDP, is included in the game program which is read out from the memory card 53 and stored in the RAM 43.

The bill validator 22 reads an image of the bill and accommodates the normal bill in the cabinet 11. In addition, in accommodating the normal bill, the bill validator 22 outputs an input signal to the main CPU 41, based on an amount of the bill. The main CPU 41 stores a credit-number, which corresponds to the amount of the bill transmitted by the input signal, in the RAM 43.

The ticket printer 35 prints a barcode having data encoded thereto, such as credit-number stored in the RAM 43, date and time, identification number of the slot machine 10 and the like, on a ticket, based on the control signal outputted from the main CPU 41, thereby outputting the ticket 39 having the barcode.

The card reader 36 reads the data from the smart card to transmit it to the main CPU 41, and writes the data into the smart card, based on the control signal outputted from the main CPU 41. The key switch 38S is mounted to the keypad 38, and outputs an input signal to the main CPU 41 when the player manipulates the keypad 38. The data displayer 37 displays the data which is read by the card reader 36 or the data which the player inputs through the keypad 38, based on the control signal outputted from the main CPU 41.

The door PCB 80 is connected with the control panel 20, a reverter 21S, a coin counter 21C and a cold cathode tube 81. The control panel 20 is provided with a spin switch 23S corresponding to the spin button 23, a change switch 24S corresponding to the change button 24, a cash out switch 25S corresponding to the cash out button 25, a 1-BET switch 26S corresponding to the 1-BET button 26 and a MAX-BET switch 27S corresponding to the MAX-BET button 27. Each of the switches 23S˜27S outputs an input signal to the main CPU 41 when each of the corresponding buttons 23˜27 is pushed by a player.

The coin counter 21C is mounted in the coin receiving slot 21 and validates whether a coin, which is inserted in the coin receiving slot 21 by the player, is normal or not. A coin except the normal coin is discharged from the coin payout slot 19. In addition, the coin counter 21C outputs an input signal to the main CPU 41 when it detects a normal coin.

The reverter 21S is operated on the basis of the control signal outputted from the main CPU 41 and distributes a coin, which is recognized as a normal coin by the coin counter 21C, to a cash box (not shown) or hopper 66 mounted in the slot machine 10. In other words, when the hopper 66 is fully filled with the coins, the normal coin is distributed into the cash box by the reverter 21S. In the mean time, when the hopper 66 is not fully filled with the coins, the normal coin is distributed into the hopper 66. The cold cathode tube 81 functions as a backlight mounted to rear sides of the lower image display panel 16 and the upper image display panel 33 and is turned on, based on the control signal outputted from the main CPU 41.

(Processing Operation: Main CPU 41)

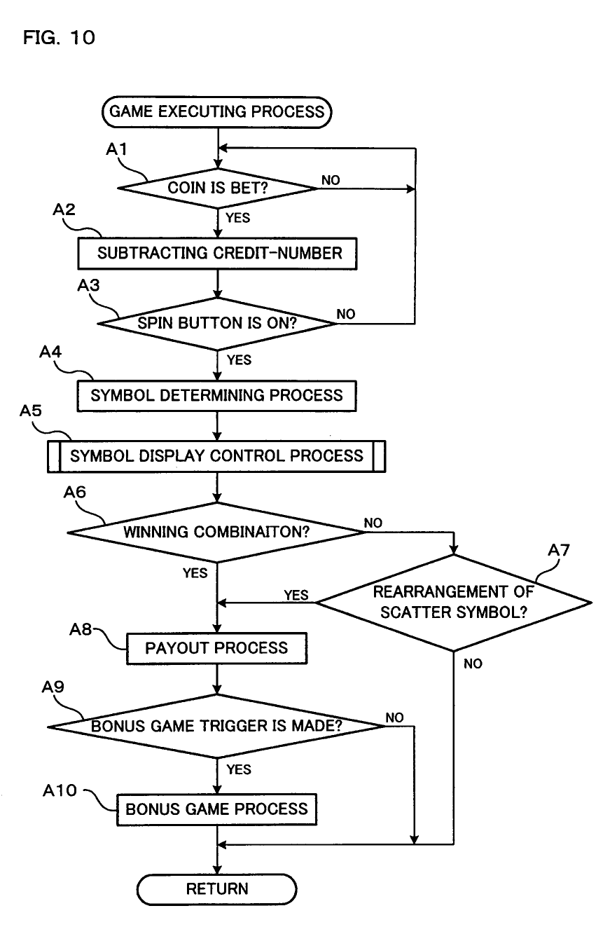

In the followings, it will be described a process which is carried out in the slot machine 10. When the main CPU 41 reads out and executes the game program, a game is started. As shown in FIG. 10, in the game executing process, it is determined whether a coin is bet (A1). In this process, it is determined whether it is received an input signal from the 1-BET switch 26S as the I-BET button 26 is pushed and whether it is received an input signal from the MAX-BET switch 27S as the MAX-BET button 27 is pushed. When the coin is not bet (A1: NO), the step of A1 is re-executed and it is under standby state until a coin is bet.

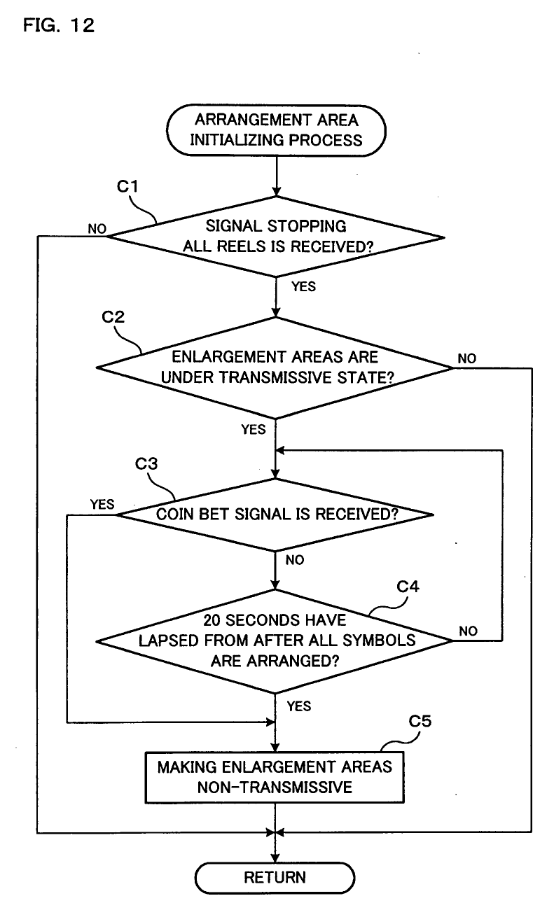

In the mean time, when the coin is bet (A1: YES), the credit-number stored in the RAM 43 is subtracted, correspondingly to the number of coins bet (A2). Meanwhile, if the number of coins bet is larger than the credit-number stored in the RAM 43, it is not carried out the process of subtracting the credit-number and the process proceeds to a step of A4. In addition, if the number of coins bet is above the upper limit (50 pieces in this embodiment) which can be bet per one game, it is not carried out the process of subtracting the credit-number and the process proceeds to a step of A4. In addition, at this time, a coin bet signal in the main CPU 41 is transmitted to an arrangement area initializing process routine which is executed as a separate process. The arrangement area initializing process routine will be specifically described with reference to FIG. 12.

Then, it is determined whether the spin button 23 is ON or not (A3). When the spin button 23 is not ON (A3: NO), the procedure is returned to the step of A1. Meanwhile, in case that the spin button 23 is not ON (for example, the spin button 23 is not ON and an instruction to end the game is inputted), it is canceled the subtraction result in the step of A2.

In the mean time, when the spin button 23 is ON (A3: YES), a symbol determining process is executed (A4). In other words, a stop symbol determining program stored in the RAM 43 is executed, so that it is determined the symbols 180 which will be stopped in the three display windows 151˜153. Thereby, it is determined a combination of symbols to be stopped on the payline L.

After that, the symbol display control process is executed (A5), so that the reels 14 are rotated to scroll the symbols 180 of the display windows 151˜153, as shown in FIG. 3. Meanwhile, the scroll process is such a process that the symbols 180 are scrolled in the arrow direction and the symbols 180 determined in the step of A4 are then stopped (rearranged) in the display windows 151˜153.

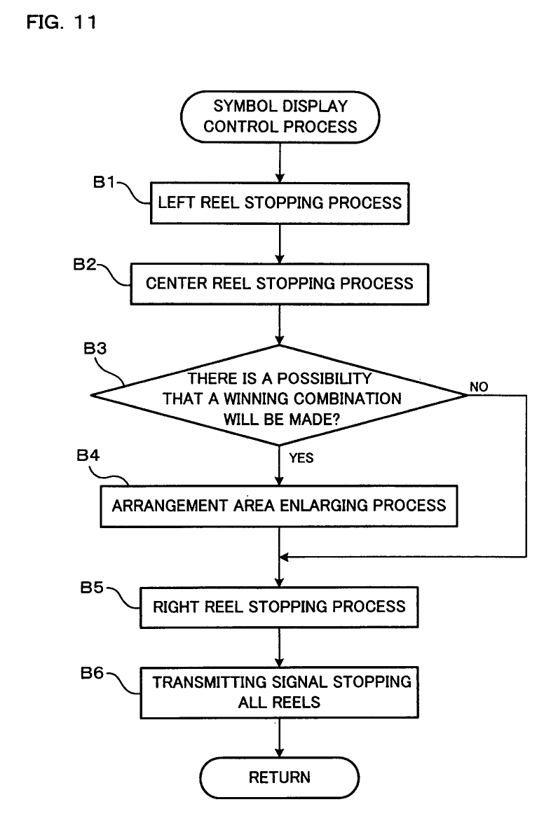

Specifically, the symbol display control process routine of FIG. 11 is executed. First, a left reel stop process is executed (B1) and the left reel 14L is stopped so that the symbols determined in the step of A4 in FIG. 10 are stopped (rearranged) in the display window 151. Continuously, a center reel stop process is executed (B2) and the center reel 14C is stopped so that the symbols determined are stopped (rearranged) in the display window 152.

In the state before the symbols of the display window 153 are stopped, it is determined whether there is a possibility that a winning combination will be made (B3). Specifically, when the symbols of the display window 153 are stopped, it is determined whether there is a possibility that a winning combination will be made on the same payline. When there is no possibility that a winning combination will be made (B3: NO), the process proceeds to a step of B5.

In addition, when there is a possibility that a winning combination will be made (B3: YES), in the display window 153, as shown in FIG. 4, the areas of the scroll direction (enlargement areas 153a, 153c) become transmissive and the width of the display window 153 is enlarged in the scroll direction so that the arrangement number of the symbols 180 is increased (B4). In other words, “BELL” is arranged and stopped on the payline L and the width of the display window 153 is enlarged in the scroll direction of the symbols 180. Thereby, it is possible to enable the player to easily understand the scroll of the symbols 180. At the same time, it is possible to make the player pay attention to the display windows 151˜153, so that the player can recognize that “BELL” is stopped in the display window 153 and a winning combination is thus made. After that, a right reel stop process is executed (B5) and the right reel 14R is stopped so that the three symbols determined are stopped (rearranged) in the display window 153. Then, a signal stopping all the symbols is transmitted to the arrangement area initializing process routine (B6), the symbol display control process routine is ended and the process returns to a game executing process routine of FIG. 10.

Continuously, as shown in FIG. 5 (the enlargement areas 153a, 153c are under transmissive state), when the scroll of the symbols 180 of the display windows 151˜153 is stopped, it is determined whether a combination of the symbols 180 stopped on the payline L is a winning combination or not (A6). When it is not a winning combination (A6: NO), it is continuously determined whether a scatter symbol is displayed (rearranged) in the display windows 151˜153 (A7). When a scatter symbol is not displayed (A7: NO), this routine is ended.

In the mean time, when it is a winning combination (A6: YES), a payout process is executed (A8). In other words, when a winning of the winning combination is made, it is calculated the payout-number of the coins based on the winning. In addition, when a winning of the scatter symbol is made, it is calculated the payout-number of the coins based on the display-number of the scatter symbol. Then, it is summed the payout-number of the coins based on the winning combination and the scatter symbol.

When the coins to be paid out are deposited, the predetermined number of credits is added to the credit-number stored in the RAM 43. In the mean time, when the coins are paid out, a control signal is transmitted to the hopper 66, so that the predetermined number of coins is paid out into the coin tray 18.

Then, it is determined whether a bonus trigger as a winning combination is made or not (A9). In other words, it is determined whether a combination of “APPLE” is arranged on the payline. When it is determined that a bonus trigger is made (A9: YES), a bonus game process is executed (A10). Meanwhile, when a bonus trigger is not made (A9: NO), the bonus game process of this routine is executed and then this routine is ended.

Then, it is described the arrangement area initializing process routine which is executed as a process different from the game executing process, with reference to FIG. 12. First, from the symbol display control process routine called from the game executing process, it is determined whether a signal stopping all the reels is received or not (C1). When the signal is not received (C1: NO), this routine is ended. When the signal is received (C1: YES), it is determined whether the enlargement areas 153a, 153c are under transmissive state or not (C2). When the enlargement areas 153a, 153c are not under transmissive state (C2: NO), this routine is ended.

In the mean time, when the enlargement areas 153a, 153c are under transmissive state (C2: YES), it is determined whether a coin bet signal is received from the game executing process routine (C3). When the coin bet signal is received (C3: YES), the enlargement areas 153a, 153c are made to be non-transmissive state (C5) and then this routine is ended. Meanwhile, when the coin bet signal is not received (C3: NO), it is determined whether a predetermined time period (20 seconds in this embodiment) has lapsed from after all the symbols are arranged (C4). When a predetermined time period has not lapsed from after all the symbols are arranged (C4: NO), the process returns to the step of C3. In the mean time, when a predetermined time period has lapsed from after all the symbols are arranged (C4: YES), the enlargement areas 153a, 153c are made to be non-transmissive state (C5) and then this routine is ended.

Although the above descriptions have been provided with regard to the characteristic parts so as to understand the invention more easily, the invention is not limited to the embodiments as described above and can be applied to the other embodiments and the applicable scope should be construed as broadly as possible. Furthermore, the terms and phraseology used in the specification have been used to correctly illustrate the invention, not to limit it. In addition, it will be understood by those skilled in the art that the other structures, systems, methods and the like included in the spirit of the invention can be derived from the spirit of the invention described in the specification. Accordingly, it should be considered that the invention covers equivalent structures thereof without departing from the spirit and scope of the invention as defined in the following claims. Further, the abstract is provided so that an intellectual property office and a general public institution or one skilled in the art who is not familiar with patent and legal or professional terminology can quickly analyze the technical features and essences of the invention through a simple investigation. Accordingly, the abstract is not intended to limit the scope of the invention that should be evaluated by the claims. In addition, it is required to sufficiently refer to the documents that have been already disclosed, so as to fully understand the objects and effects of the invention.

The above descriptions include a process that is executed on a computer or computer network. The above descriptions and expressions have been provided so that the one skilled in the art can understand the invention most effectively. In the specification, the respective steps used to induce one result or blocks having a predetermined processing function should be understood as a process having no self-contradiction. In addition, the electrical or magnetic signal is transmitted/received and written in the respective steps or blocks. Although the processes in the respective steps or blocks embody the signal as a bit, value, symbol character, term, number and the like, it should be noted that these have been used for the convenience of descriptions. Further, although the processes in the respective steps or blocks have been often described as an expression common to a human action, the process described in the specification is executed by a variety of devices in principle. In addition, the other structures necessary for the respective steps or blocks are apparent from the above descriptions.

What is claimed is:

1. A slot machine comprising:
plural symbols arranged in a plurality of areas;
a symbol arranging device for arranging the plural symbols in the areas; and
a game controller programmed to enable the symbol arranging device,
(a) to scroll and rearrange each of the symbols in each of the areas, respectively, based on a predetermined timing,
(b) to determine a winning through a relation of the symbols rearranged, and
(c) under state before the symbol is rearranged in a part of the area, when a symbol to be rearranged in the area is at a stage having a possibility that a winning will occur in connection with the symbols having been already rearranged in the areas, to enlarge an area width in the scroll direction so that an arrangement number of the symbols is increased, for the area in which the symbols are scrolled.

2. A slot machine comprising:
a display having a plurality of areas for arranging plural symbols; and
a game controller programmed to enable the display,
(a) to scroll and rearrange the symbols in each of the areas, respectively, based on a predetermined timing,
(b) to determine a winning through a relation of the symbols rearranged, and
(c) under state before the symbol is rearranged in a part of the area, when a symbol to be rearranged in the area is at a stage having a possibility that a winning will occur in connection with the symbols having been already rearranged in the areas, to enlarge an area width in the scroll direction so that an arrangement number of the symbols is increased, for the area in which the symbols are scrolled.

3. A slot machine comprising:
a plurality of reels having plural symbols attached to each periphery thereof;
a display provided to a front of the reels, having plural arrangement areas transmitting to arrange the symbols of the reels and being transmissive to any area; and
a game controller programmed to enable the respective reels and the display,
(a) to rotate each of the reels on the basis of a predetermined timing, thereby scrolling and rearranging the symbols in the respective arrangement areas,
(b) to determine a winning through a relation of the symbols rearranged,
(c) under state before the symbol is rearranged in a part of the area, when a symbol to be rearranged in the area is at a stage having a possibility that a winning will occur in connection with the symbols having been already rearranged in the areas, to make the areas of the scroll direction transmissive and to enlarge an area width in the scroll direction so that an arrangement number of the symbols is increased, for the area in which the symbols are scrolled.

4. A slot machine comprising:
a symbol arranging device for arranging plural symbols in a plurality of areas; and
a game controller programmed to enable the symbol arranging device,
(a) to scroll and rearrange the symbols in each of the areas, respectively, based on a predetermined timing,
(b) to determine a winning through a relation of the symbols rearranged, and
(c) under state before the symbol is rearranged in a part of the area, when a symbol to be rearranged in the area is at a stage having a possibility that a winning will occur in connection with the symbols having been already rearranged in the areas, to enlarge an area width in the scroll direction so that an arrangement number of the symbols is increased, for the area in which the symbols are scrolled, until a predetermined time period has lapsed from after the symbols are rearranged in all the areas.

5. A slot machine comprising:
a display having a plurality of areas for arranging plural symbols; and
a game controller programmed to enable the display,
(a) to scroll and rearrange the symbols in each of the areas, respectively, based on a predetermined timing,
(b) to determine a winning through a relation of the symbols rearranged, and
(c) under state before the symbol is rearranged in a part of the area, when a symbol to be rearranged in the area is at a stage having a possibility that a winning will occur in connection with the symbols having been already rearranged in the areas, to enlarge an area width in the scroll direction so that an arrangement number of the symbols is increased, for the area in which the symbols are scrolled, until a predetermined time period has lapsed from after the symbols are rearranged in all the areas.

6. A slot machine comprising:
a plurality of reels having plural symbols attached to each periphery thereof;
a display provided to a front of the reels, having plural arrangement areas transmitting to arrange the symbols of the reels and being transmissive to any area; and
a game controller programmed to enable the respective reels and the display,
(a) to rotate the respective reels on the basis of a predetermined timing, thereby scrolling and rearranging the symbols in the respective arrangement areas,
(b) to determine a winning through a relation of the symbols rearranged, and
(c) under state before the symbol is rearranged in a part of the area, when a symbol to be rearranged in the area is at a stage having a possibility that a winning will occur in connection with the symbols having been already rearranged in the areas, to make the areas of the scroll direction transmissive and to enlarge an area width in the scroll direction so that an arrangement number of the symbols is increased, for the area in which the symbols are scrolled, until a predetermined time period has lapsed from after the symbols are rearranged in all the areas.

7. A playing method of a slot machine for repeatedly executing a unit game in which plural symbols arranged by a symbol arranging device are rearranged, the symbol arranging device having a plurality of areas for arranging the plural symbols, the playing method comprising steps of:
(a) scrolling and rearranging the symbols in each of the areas, respectively, based on a predetermined timing;
(b) determining a winning thorough a relation of the symbols rearranged; and
(c) under state before the symbol is rearranged in a part of the area, when a symbol to be rearranged in the area is at a stage having a possibility that a winning will occur in connection with the symbols having been already rearranged in the areas, enlarging an area width in the scroll direction so that an arrangement number of the symbols is increased, for the area in which the symbols are scrolled.

8. A playing method of a slot machine for repeatedly executing a unit game in which plural symbols arranged by a display are rearranged, the display having a plurality of areas for arranging the plural symbols, the playing method comprising steps of:
(a) scrolling and rearranging each of the plural symbols in each of the areas, respectively, based on a predetermined timing;
(b) determining a winning thorough a relation of the symbols rearranged; and
(c) under state before the symbol is rearranged in a part of the area, when a symbol to be rearranged in the area is at a stage having a possibility that a winning will occur in connection with the symbols having been already rearranged in the areas, enlarging an area width in the scroll direction so that an arrangement number of the symbols is increased, for the area in which the symbols are scrolled.

9. A playing method of a slot machine comprising a game controller for repeatedly executing a unit game in which plural symbols arranged by a display are rearranged, the plural symbols being attached to peripheries of plural reels, and the display having a plurality of areas for transmitting to arrange the symbols of the reels, transmissive to any area and provided to a front of the plural reels, the playing method comprising steps of:
(a) rotating the respective reels on the basis of a predetermined timing, thereby scrolling and rearranging the symbols in the respective arrangement areas,
(b) determining a winning through a relation of the symbols rearranged, and
(c) under state before the symbol is rearranged in a part of the area, when a symbol to be rearranged in the area is at a stage having a possibility that a winning will occur in connection with the symbols having been already rearranged in the areas, making the areas of the scroll direction transmissive and enlarging an area width in the scroll direction so that an arrangement number of the symbols is increased, for the area in which the symbols are scrolled.

10. A playing method of a slot machine for repeatedly executing a unit game in which plural symbols arranged by a symbol arranging device are rearranged, the symbol arranging device having a plurality of areas for arranging the symbols, the playing method comprising steps of:
(a) scrolling and rearranging each of the symbols in each of the areas, respectively, based on a predetermined timing,
(b) determining a winning through a relation of the symbols rearranged, and
(c) under state before the symbol is rearranged in a part of the area, when a symbol to be rearranged in the area is at a stage having a possibility that a winning will occur in connection with the symbols having been already rearranged in the areas, enlarging an area width in the scroll direction so that an arrangement number of the symbols is increased, for the area in which the symbols are scrolled, until a predetermined time period has lapsed from after the symbols are rearranged in all the areas.

11. A playing method of a slot machine for repeatedly executing a unit game in which plural symbols arranged by a display are rearranged, the display having a plurality of areas for arranging the symbols, the playing method comprising steps of:
(a) scrolling and rearranging the symbols in each of the areas, respectively, based on a predetermined timing,
(b) determining a winning through a relation of the symbols rearranged, and
(c) under state before the symbol is rearranged in a part of the area, when a symbol to be rearranged in the area is at a stage having a possibility that a winning will occur in connection with the symbols having been already rearranged in the areas, to enlarge an area width in the scroll direction so that an arrangement number of the symbols is increased, for the area in which the symbols are scrolled, until a predetermined time period has lapsed from after the symbols are rearranged in all the areas.

12. A playing method of a slot machine comprising a game controller for repeatedly executing a unit game in which plural symbols arranged by a display are rearranged, the plural symbols being attached to peripheries of plural reels, and the display having a plurality of areas for transmitting to arrange the symbols of the reels, transmissive to any area and provided to a front of the plural reels, the playing method comprising steps of:
(a) rotating the respective reels on the basis of a predetermined timing, thereby scrolling and rearranging the symbols in the respective arrangement areas,
(b) determining a winning through a relation of the symbols rearranged, and
(c) under state before the symbol is rearranged in a part of the area, when a symbol to be rearranged in the area is at a stage having a possibility that a winning will occur in connection with the symbols having been already rearranged in the areas, making the areas of the scroll direction transmissive and enlarging an area width in the scroll direction so that an arrangement number of the symbols is increased, for the area in which the symbols are scrolled, until a predetermined time period has lapsed from after the symbols are rearranged in all the areas.
